(19) United States
(12) Patent Application Publication
(10) Pub. No.: US 2025/0374853 A1
(43) Pub. Date: Dec. 11, 2025

(54) MODEL-SENSOR FUSION FOR CROP MANAGEMENT DECISION SUPPORT

(71) Applicant: SENTINEL AG, INC., Ithaca, NE (US)

(72) Inventor: Jackson Stansell, Columbia, AL (US)

(21) Appl. No.: 19/233,982

(22) Filed: Jun. 10, 2025

Related U.S. Application Data
(60) Provisional application No. 63/658,319, filed on Jun. 10, 2024.
(60) Provisional application No. 63/713,300, filed on Oct. 29, 2024.

(51) Int. Cl. A01C 21/00

(52) U.S. Cl. CPC A01C 21/007; A01C 21/005

(57) ABSTRACT

A system is disclosed. The system includes a controller, wherein the controller includes one or more processors configured to execute program instructions stored on memory, the program instructions configured to cause the one or more processors to: receive information of a natural environment and management practices; begin automated data collection; update information of the natural environment and the management practices on a set time interval; quantify the relationship between predicted field needs and the actual field needs; calibrated based on the relationship between the predicted field needs and the actual field needs; and provide recommendations based on the predicted field needs.

### CROSS-REFERENCE TO RELATED APPLICATIONS

The present application claims the benefit under 35 U.S.C. § 119 (e) of U.S. Provisional Application Ser. No. 63/658,319, filed Jun. 10, 2024, entitled MODEL-SENSOR FUSION FOR CROP MANAGEMENT DECISION SUPPORT, and U.S. Provisional Application Ser. No. 63/713,300, filed Oct. 29, 2024, entitled MODEL-SENSOR FUSION FOR CROP MANAGEMENT DECISION SUPPORT, both of which are incorporated herein by reference in the entirety.

### TECHNICAL FIELD

This disclosure relates broadly to crop management, and, more particularly, to crop management based on environmental data.

### BACKGROUND

One prior method of crop management is designed for irrigated land and dryland for early to late nitrogen sidedress applications. The method employs a nitrogen rate average, where the rate varies from the average based on sensor data. The sensor data may be calibrated with a nitrogen rich strip. However, this method is flawed because the model does not calibrate how correctly the model predicts yield potential, does not consider uncertainty, does not error correct the model's approach to optimal management using in-season data, and does not train the model with reinforcement learning on the field the model is being applied to. This method is discussed in Teten, Samantha L. “Sensor-Based Nitrogen Management on Non-Irrigated Corn Based Systems in Nebraska.” (2021), which is incorporated herein by reference in its entirety.

An additional method models yield loss as a result of nitrogen deficiency and uses coarse satellite data to recommend rescue nitrogen applications. However, this model does not use in-field calibration.

Additionally, a method of predicting crop yield loss due to nitrogen deficiency is disclosed in U.S. Pat. No. 8,520,891, which is incorporated herein by reference in its entirety.

Crop production models may be quantitative representations of crop growth resulting from interactions between factors such as, but not limited to, crop genetics, soil dynamics (e.g., soil physical, chemical, and/or biological properties) and environmental conditions (e.g., weather, climate, location, and/or landscape position attributes). These models may be mechanistic or empirical. Mechanistic models may use equations based on theory or observation to represent processes included in the model (e.g. nitrogen fixation). Empirical models may use equations quantitatively derived from crop, soil, and environmental data with little or no reliance on mechanistic understanding of the relationship between the data. Mechanistic models may translate better across geographies and crop production systems. However, mechanistic models may require significant data availability and input. Empirical models may be overfitted to specific geographies but may only require the data used to derive them, which allows for significant dimensionality reduction.

Crop production models may be most useful for estimating crop response to different things such as, but not limited to management practices (e.g., nitrogen application), weather (e.g., recent precipitation), and climate scenarios (e.g., seasonal growing degree day forecasts). Crop production models may be predictive and therefore may be useful for general planning. Agricultural professionals and farmers have historically used models to make nitrogen management plans for crops prior to planting, often determining a total amount to apply to the crop and applying it before the crop is planted. As machinery advances, techniques improve, profit margins get slimmer, and regulations on nitrogen management practices are implemented farmers and agronomists are shifting toward splitting the total amount of applied nitrogen between pre-planting and post-planting (or in-season) applications. Yield potential of the crop may be highly uncertain prior to, and for a significant period after, planting due to its dependence on weather. As time progresses and crops mature, yield potential may become more certain. Therefore, waiting to apply more nitrogen in-season may offer the opportunity to adjust the nitrogen management plan to match crop yield potential.

Some farmers and agronomists have turned to using models that are executed during crop growth to inform nitrogen management plan adjustments. Models may be a reliable decision support tool for farmers and agronomists because they can be executed on-demand in any atmospheric conditions, and they do not rely on network connections to in-field sensors to work. However, adjustments made based on these models can be inaccurate and negatively impact yield or cause excessive nitrogen applications that are harmful to the environment. Mechanistic and empirical model accuracy for a given crop production scenario may only be as good as the quality (e.g., availability, resolution, accuracy, etc.) of the data used to train or derive the model, the quality of the data input to the model for the crop production scenario, and/or the extent to which the model creators understood the system being modeled. In other words, models carry significant uncertainty. Specifically, much of model uncertainty is driven by sparse weather data (e.g., regional weather data of about a 25 kilometer (km) measure, instead of field scale of about 0.5 km), inaccurate weather data (e.g., modeled itself instead of collected), incomplete crop production information (e.g., missing tillage information or missing irrigation event log), and/or incomplete models (e.g., no inclusion of relative soil biological activity). Calibrating these models to field-specific conditions and data availability is a multi-year effort.

An alternative to model-informed nutrient management planning adjustments is sensor-based nitrogen management. Sensor-based nutrient management uses data related to crop nitrogen status collected at high-resolution (e.g., sub-field scale) during crop growth and often at high temporal frequency (e.g., weekly, or more often) to inform decisions. The quality and availability of this data (if processed correctly) may make it highly reliable for determining crop nutrient demand. However, the data is often reactive (e.g., measured after crop nitrogen deficiency has occurred or too close for management actions to prevent deficiency) and data collection can be impeded by atmospheric conditions (e.g., clouds or haze) or poor network connectivity (e.g., weak cellular connections).

Vegetation indices, derived from crop reflectance data in the visible, near-infrared, and thermal radiation wavebands, are used to estimate nutrient availability and hydration levels in crops. However, these indices are not nutrient-specific, as a single index often correlates with multiple nutrients as well as other stress factors such as pest and disease pressure. Additionally, vegetation indices are highly sensitive to crop cultivar differences; each cultivar or crop type exhibits a unique range of index values due to variations in their relative “greenness.” As a result, separate models must be developed for each cultivar or crop. This poses a significant challenge due to the wide diversity of cultivars across regions, the rapid pace of new cultivar development, and the extensive time required to collect the data necessary to train accurate models for each one.

Spectral reflectance of plant biomass can be measured either proximally or remotely, and the resulting spectral signature can help identify a crop's nutritional or hydration needs. However, this method faces similar limitations to those of vegetation indices. It requires high spectral resolution, meaning very narrow wavebands, which can be costly or demand specialized equipment. Additionally, spectral reflectance is sensitive to cultivar differences, as each cultivar may exhibit distinct spectral characteristics, necessitating customized calibration or models for accurate interpretation.

Analyzing plant or soil matter for its chemical, physical, and biological composition, including the concentration of elements and nutrients, requires collecting physical samples, often involving destructive methods that damage or consume the material. These analyses may also include genetic testing to examine the expression of specific genes. However, the accuracy of results can be affected by changes in temperature and moisture between the time of collection and the actual analysis, potentially altering the state of the sample. While certain on-site analysis techniques and best practices can help minimize these issues, another challenge is the lack of clearly defined optimal nutrient ratios for specific cultivars, as different varieties may have unique nutrient requirements. For example, some may need less sulfur relative to nitrogen.

Genetic modification can be used to engineer plants that visibly or otherwise detectably express signs of nutritional or hydration stress before such stress impacts yield potential. However, this approach has several limitations. It requires the use of genetically modified seeds or plant stock, which may not be available for all cultivars, which may restrict the choices available to farmers and agronomists. Additionally, the stress signals produced by these modifications may be too subtle to detect without extensive field scouting. Further, genetically modified crops face regulatory challenges and may be less financially viable due to market resistance or reduced consumer demand for genetically modified produce.

It may therefore be beneficial to provide method and system that cures the above deficiencies.

### SUMMARY

A system is disclosed, in accordance with one or more embodiments of the present disclosure. In embodiments, the system includes a controller, wherein the controller includes one or more processors configured to execute program instructions stored on memory. The program instructions are configured to cause the one or more processors to perform one or more of the following steps: receive information of a natural environment and management practices; begin automated data collection; update information of the natural environment and the management practices on a set time interval; quantify the relationship between predicted field needs and the actual field needs; calibrate based on the relationship between the predicted field needs and the actual field needs; and provide recommendations based on the predicted field needs.

A system is disclosed, in accordance with one or more embodiments of the present disclosure. In embodiments, the system includes one or more sensors. In embodiments, the system includes nutrient application equipment. In embodiments, the system includes a controller, wherein the controller includes one or more processors configured to execute program instructions stored on memory. The program instructions are configured to cause the one or more processors to perform one or more of the following steps: receive information of a natural environment and management practices; begin automated data collection; update information of the natural environment and the management practices on a set time interval; quantify the relationship between predicted field needs and the actual field needs; calibrate based on the relationship between the predicted field needs and the actual field needs; provide recommendations based on the predicted field needs; and control the nutrient application equipment based on determinations of field needs.

A method is disclosed, in accordance with one or more embodiments of the present disclosure. In embodiments, the method includes a step of receiving information of a natural environment and management practices. In embodiments, the method includes a step of beginning automated data collection. In embodiments, the method includes a step of updating information of the natural environment and the management practices on a set time interval. In embodiments, the method includes a step of quantifying the relationship between predicted field needs and the actual field needs. In embodiments, the method includes a step of calibrating based on the relationship between the predicted field needs and the actual field needs. In embodiments, the method includes a step of providing recommendations based on the predicted field needs.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims.

FIG. 1 illustrates a block diagram of a system for nutrient calibration, in accordance with one or more embodiments of the present disclosure.

FIG. 2 illustrates a flow diagram of a method for nutrient calibration, in accordance with one or more embodiments of the present disclosure.

FIG. 3 illustrates a flow diagram of a method for configuring a system by receiving information of a natural environment and management practices, in accordance with one or more embodiments of the present disclosure.

FIG. 4 illustrates a flow diagram of a method for updating information of the natural environment and the management practices on a set time interval, in accordance with one or more embodiments of the present disclosure.

FIG. 5 illustrates a flow diagram of a method for quantifying a relationship between predicted field needs and actual field needs, in accordance with one or more embodiments of the present disclosure.

FIG. 6 illustrates a flow diagram of a method for determining actual field needs based on observational data, in accordance with one or more embodiments of the present disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

A solution for comprehensive nutrient management decision support may be a fusion of model-based and sensor-based approaches. This fusion may allow the model to arrive at the most optimal nutrient management decisions with the information available at any point during crop growth. Models may be used for estimating the optimal nutrient amount to apply to the crop prior to planting and generally how to split nutrients between an initial application at, or prior to, planting and in season application(s). Sensor data (e.g., imagery, weather data (e.g., rainfall, growing degree days, humidity, windspeed, hail, or other extreme weather events), irrigation history, soil moisture, soil nutrient content, spectrometry for leaf color, or the like) may be used in conjunction with the model to adjust or correct nutrient applications in-season.

The present application relates to U.S. Patent Application Publication No. 20230018041A1, published on Jan. 19, 2023 and U.S. patent application Ser. No. 18/790,919, filed on Jul. 31, 2024, both of which are incorporated herein by reference in their entirety.

Though specific periods of time may be included in the present disclosure, the system disclosed herein is designed to accept and adapt to user-specified inputs for the predictive interval used in nutrient rate recommendations, demand predictions, and the like. Additionally, such a system may similarly be applied to any nutrients required for optimal crop production including nitrogen (N), sulfur(S), potassium (K), phosphorus (P), boron (B), magnesium (Mg), zinc (Zn), manganese (Mn), calcium (Ca), iron (Fe), molybdenum (Mo), copper (Cu), chlorine (Cl), and other necessary nutrients for crop production. Such a system may be used to address crops including cereal grains (e.g., corn, wheat, rice, rye, barley, or oats), cotton, potatoes, forages (e.g., orchard grass or alfalfa), sugar beets, sugar cane, lettuce, tomatoes, and other crops.

The model disclosed in the present disclosure may allow users to manage crops without the need for in situ or manual data collection (e.g., no hardware may be required).

Additionally, the model may be calibrated based on a variety of factors such as specific genetics, environment, management interactions, and/or specific variety or hybrid. Calibration may be crop-specific and can work in multiple crops. The model may operate as a spatially specific model as required (e.g., operate for each field or subset of a field). The model may not require exact data inputs to approach high levels of precision and accuracy. Additionally, calibration may be done automatically, without the need for data input, and may occur during the growing season. The model may also include a built-in learning process to aid calibration. Calibration may provide for high temporal resolution correction. However, it should be noted that calibration may not always occur and the model may be implemented uncalibrated.

The model may be applicable and adaptive to a wide range of application techniques and strategies. Timing, rate, location, and formulation of the fertilizer may be adjusted simultaneously. The model may provide advanced warning of anticipated nutrient demand. The model may dynamically predict remaining nutrient demand for a set number of days during the growing season and predict the amount, or type, of fertilizer required to satisfy crop nutrient demand for the remaining growing season. The model may forecast the range of yield and profitability gains for nutrient applications during the growing season. The model may anticipate a nutrient application schedule to coordinate labor for upcoming applications. The model may provide recommendations that are adaptive to the data that is available (e.g., the model may provide recommendations when information about the natural environment is insufficient) and leverage the information gleaned from other data to that point and allow for recommendations even when sensor data is impeded. The model may also provide recommendations for a defined future time period (e.g., 2 weeks, 4 weeks, or the remainder of the growing season).

The model may run regularly for multiple different management scenarios and spatial locations in a field. The model may further be part of a mixed model approach with State Model and State Model Management Agent. Users may fill unknown management inputs in the model. Additionally, best practice values may be used to supply any unknown management inputs (e.g., the best practice values may be automatically used or may be provided as recommendations to a user). The model provides real-time and continuous feedback calibration of modeled stress, modeled current demand, and recommended management intervention. The model also has real-time training of the State Model Management Agent.

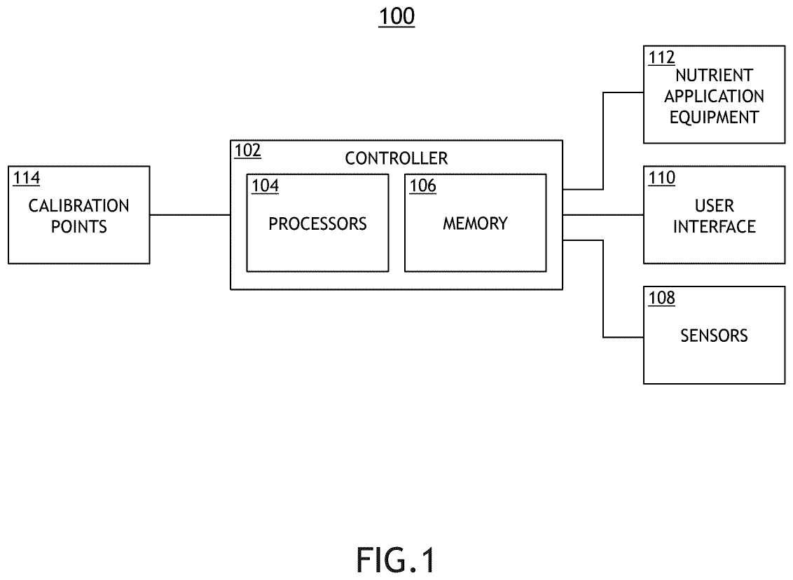

FIG. 1 illustrates a block diagram of a system 100 for nutrient calibration, in accordance with one or more embodiments of the present disclosure.

In embodiments, the system 100 further includes a controller 102 communicatively coupled to any components therein. In embodiments, the controller 102 includes one or more processors 104. For example, the one or more processors 104 may be configured to execute a set of program instructions maintained in a memory 106.

The controller 102 may direct (e.g., through control signals) and/or receive data from any components or sub-systems of the system 100 such as, but not limited to a set of sensors 108. For example, the sensors 108 may be configured to collect multispectral optical reflectance data. This multispectral optical reflectance data may be used with the system 100, and the program instructions defined herein to cause the system 100 to perform augmented simulant calibration. The controller 102 may further be configured to perform, or cause another component to perform, any of the various process steps described throughout the present disclosure.

The sensors 108 may also be configured to measure in-field soil salinity levels and/or nitrate concentration along with the optical reflectance measurements of the crop canopy. Additionally, the sensors 108 may be in situ crop sensors 108 and soil sensors 108 implemented for mass balance on water and nutrients.

Additionally, data such as multiple geospatial and geo-independent data structures that characterize relative soil properties, landscape position, crop genetics, management practices, and other variables potentially relevant to any crop production model may be obtained via the sensors 108, manually entered, or may be retrieved from databases.

The system 100 may also include nutrient application equipment 112 (e.g., chemigation equipment). For example, the controller 102 and/or the processors 104 therein may be configured to control (e.g., alter) operation of the nutrient application equipment 112 based on the augmented simulant calibration process. The nutrient application equipment 112 may include any nutrient application equipment known in the art, including, but not limited to, irrigation systems, pumps, and/or reservoirs. For example, based on information from the sensors 108, the processors 104 may be configured to control the nutrient application equipment 112 (e.g., control amounts of chemicals (e.g., fertilizers) or water dispersed through the nutrient application equipment 112).

For example, the nutrient application equipment 112 may include any type of nutrient application equipment, including, but not limited to fertigation equipment, chemigation equipment, sidedress equipment, high-clearance spray applicators, aircraft, drones, or the like. The specific output of this system 100 may be a recommendation (e.g., either a fixed- or a variable-rate prescription) that can be uploaded to the nutrient application equipment 112 which then executes the recommendation.

In embodiments, the system 100 includes one or more calibration points 114. The calibration points may be located in nutrient rich (e.g., nitrogen rich (N-Rich)) and/or nutrient poor (e.g., nitrogen poor (N-Poor)) soil environments that are created on a field, or that exist naturally within the field. These locations may be leveraged to perform augmented simulant calibration. Virtual calibration techniques based on statistical processes and time-series data may be used for calibration as well.

The one or more processors 104 of a controller 102 may include any processor or processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors 104 may include any device configured to execute algorithms and/or instructions (e.g., program instructions stored in memory). In some embodiments, the one or more processors 104 may be embodied as a desktop computer, mainframe computer system, workstation, image computer, parallel processor, networked computer, or any other computer system configured to execute a program configured to operate or operate in conjunction with the system 100, as described throughout the present disclosure. Moreover, different subsystems of system 100 may include a processor or logic elements suitable for carrying out at least a portion of the steps described in the present disclosure. Therefore, the above description should not be interpreted as a limitation on the embodiments of the present disclosure but merely as an illustration. Further, the steps described throughout the present disclosure may be carried out by a single controller or, alternatively, multiple controllers. Additionally, the controller 102 may include one or more controllers housed in a common housing or within multiple housings. In this way, any controller or combination of controllers may be separately packaged as a module suitable for integration into the system 100.

The memory 106 may include any storage medium known in the art suitable for storing program instructions executable by the associated one or more processors 104. For example, the memory 106 may include a non-transitory memory medium. By way of another example, the memory 106 may include, but is not limited to, a read-only memory (ROM), a random-access memory (RAM), a magnetic or optical memory device (e.g., disk), a magnetic tape, a solid-state drive, and the like. It is further noted that the memory 106 may be housed in a common controller housing with the one or more processors 104. In some embodiments, the memory 106 may be located remotely with respect to the physical location of the one or more processors 104 and the controller 102. For instance, the one or more processors 104 of the controller 102 may access a remote memory (e.g., server), accessible through a network (e.g., internet, intranet, and the like).

In embodiments, the system 100 includes a user interface 110 communicatively coupled to the controller 102. In one embodiment, the user interface 110 may include, but is not limited to, one or more desktops, laptops, tablets, and the like. In another embodiment, the user interface 110 includes a display used to display data of the system 100 to a user. The display of the user interface 110 may include any display known in the art. For example, the display may include, but is not limited to, a liquid crystal display (LCD), an organic light-emitting diode (OLED) based display, or a CRT display. Those skilled in the art should recognize that any display device capable of integration with a user interface 110 is suitable for implementation in the present disclosure. In another embodiment, a user may input selections and/or instructions responsive to data displayed to the user via a user input device of the user interface 110.

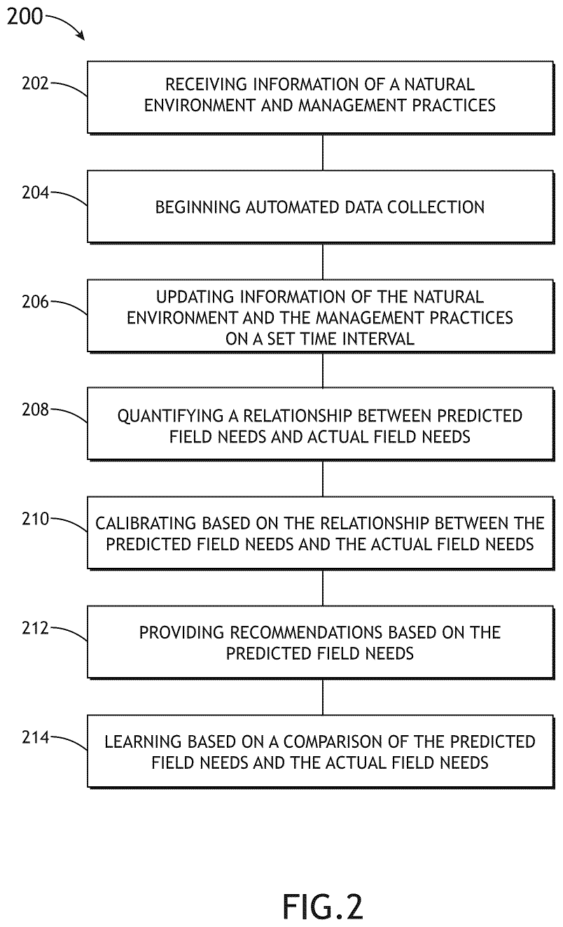

FIG. 2 illustrates a flow diagram illustrating a method 200, in accordance with one or more embodiments of the present disclosure. Applicant notes that the embodiments and enabling technologies described previously herein in the context of the system 100 should be interpreted to extend to the method 200. It is further noted, however, that the method 200 is not limited to the architecture of the system 100.

The method 200 may include the input of sensor data which can come from any sensor (e.g., imagery, weather data, including but not limited to rainfall, growing degree days, humidity, windspeed, hail or other extreme weather events, irrigation history, soil moisture, soil nitrogen content, or spectrometry for leaf color) capable of measuring crop or soil response to nitrogen. At least a State Model may be used for this approach. State Models may measure the current, historical, and forecasted state of the system based on the input data required. Additionally, a State Model Management Agent may be used to recommend management actions to the user. The State Model Management Agent may be an artificial intelligence model trained to choose the optimal management intervention to achieve a specific set of outcomes within a certain duration. This method 200 may build a State Model Management Agent that may be integrated on the second iteration of a particular crop on a particular field. However, a State Model Management Agent is not required in the system.

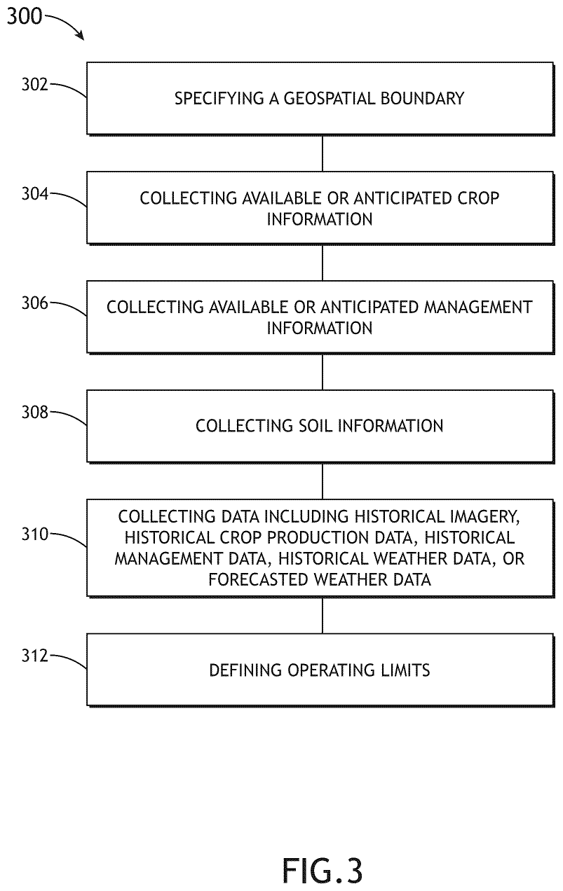

In embodiments, the method 200 includes a step 202 of configuring a system by receiving information of a natural environment and management practices. FIG. 3 illustrates a flow diagram of a method 300 for configuring a system by receiving information of a natural environment and management practices, in accordance with one or more embodiments of the present disclosure.

Configuring the system may include collecting information about variables such as, but not limited to, the field, crops to be planted, and intended practices. The information about these variables may be input into the model.

In embodiments, the method 300 for configuring a system by receiving information of a natural environment and management practices includes a step 302 of specifying a geospatial boundary (e.g., the boundary of a field, multiple fields, or a subset of a field).

In embodiments, the method 300 for configuring a system by receiving information of a natural environment and management practices includes a step 304 of collecting available or anticipated crop information for the crops to be planted (e.g., crop type, crop hybrid, crop variety, maturation data (e.g., heat units to critical growth stages), or phenotypic performance data).

In embodiments, the method 300 for configuring a system by receiving information of a natural environment and management practices includes a step 306 of collecting available or anticipated management information (e.g., the intended practices to be followed). The management information may be provided by a user or obtained from another source, such as, but not limited to a database (e.g., a database including best practices). The management information may include application information (e.g., the method, rate, composition, or timing of water, fertilizer, or chemical application), tillage information (e.g., method, depth, or timing of tillage), planting information (e.g., depth, population, or timing of planting), or harvest information (e.g., timing of harvest).

In embodiments, the method 300 for configuring a system by receiving information of a natural environment and management practices includes a step 308 of collecting soil information (e.g., physical properties of the soil, chemical properties of the soil, or biological properties of the soil).

B In embodiments, the method 300 for configuring a system by receiving information of a natural environment and management practices includes a step 310 of collecting data such as historical imagery (e.g., of the field or the area within the geospatial boundary), historical crop production data (e.g., yields), historical management data, historical weather data, or forecasted weather data (e.g., for the current growing season).

In embodiments, the method 300 for configuring a system by receiving information of a natural environment and management practices includes a step 312 of defining any operating limits that the field or crops may be subjected to.

In embodiments, the method 200 includes a step 204 of initializing the system by beginning automated data collection.

For example, initializing the system may include starting automated data collection (e.g., collection data via sensors from various areas of a field). By way of another example, initializing the system may include activating data input listeners for crop, management, and/or soil information. By way of another example, initializing the system may include activating model run listeners. By way of another example, initializing the system may include running the model at the current data based on initial conditions (e.g., weather and soil conditions). By way of another example, initializing the system may include training the model to optimize the model (e.g., the model for each field) based on historically seeded simulated weather conditions. By way of another example, initializing the system may include establishing paired nutrient rich and nutrient poor plots.

In embodiments, the method 200 may include managing the system for nutrient calibration.

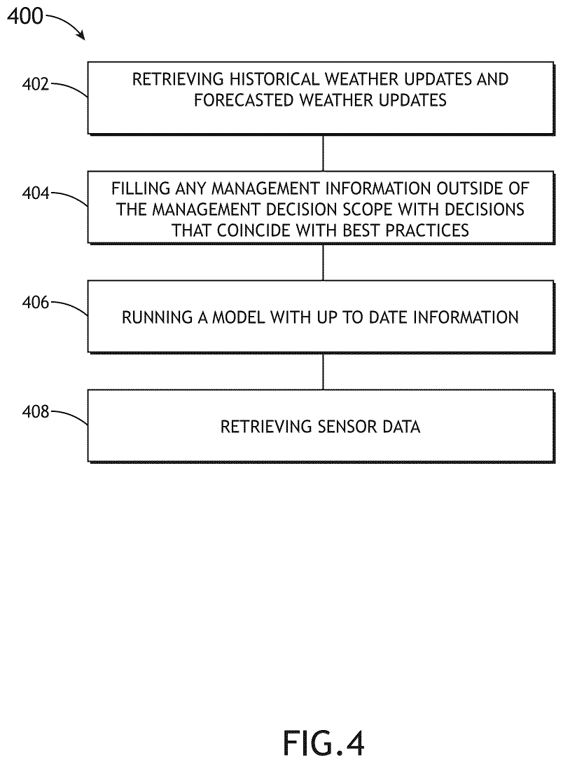

In embodiments, the method 200 may include a step 206 of updating information of the natural environment and the management practices on a set time interval. FIG. 4 illustrates a flow diagram of a method 400 for updating information of the natural environment and the management practices on a set time interval, in accordance with one or more embodiments of the present disclosure.

In embodiments, the method 400 for updating information of the natural environment and the management practices on a set time interval includes a step 402 of retrieving historical weather updates and forecasted weather updates. This may happen at any frequency (e.g., hourly, twice daily, daily, or every two days). This information, in addition to the most up to date crop information, management information, and soil information may be used to build a field information structure.

In embodiments, the method 400 for updating information of the natural environment and the management practices on a set time interval includes a step 404 of filling any management information outside of the management decision scope with decisions that coincide with best practices known in the art (e.g., decisions based on the Penman-Montieth irrigation balance for irrigation). In embodiments, decisions may be limited to making choices of application Data structures of a particular nutrient (e.g., nitrogen). However, the decisions may be made for any number of nutrients, with all other necessary nutrient decisions being automated. For example, if the model is making nutrient decisions, the model assume a best practice program for nutrients including, but not limited to, phosphorus, potassium, and sulfur. Therefore, other decisions may need to be automated. This may occur by using the available data to make scientifically recommended decisions without the need for human input.

In embodiments, the method 400 for updating information of the natural environment and the management practices on a set time interval includes a step 406 of running the model with the most up to date information (e.g., weather, crop, management, and soil information). Running the model may be triggered upon completion of water data retrieval and updating management information. The model may be run at up to the highest spatial resolution for unique interactions in the field. A model matrix (e.g., as shown in Table 1) may be run for each set of unique field information datastructures at each date within the forecast interval to return crop production attribute estimates. Forecasted and historical weather may be used to produce field information datastructures for forecast intervals. At least one field information datastructure (e.g., standard field management, limited field management, or excess field management) may be included in the model run. However, as many unique data structures as available may be included as known permutations of management and/or natural environment. Additionally, more field information datastructures may be included based on the known range of management in the field.

TABLE 1

| | | | | |
|---|---|---|---|---|
| Field Information Datastructure | t = τ | t = τ + X₁ | . . . | t = τ + Xᵢ |

Data 1
Data 2
. . .
Data N

Additionally, if a State Model Management Agent (Agent) exists, the Agent may be run at its trained forecast interval(s) for each unique field information datastructure to return management intervention recommendations. The datastructures are shown in Table 2. Forecasted and historical weather may be used to produce field information datastructures for forecast intervals. At least one field information datastructure (e.g., standard field management, limited field management, or excess field management) may be included in the model run. However, as many unique data structures as available may be included as known permutations of management and/or natural environment. Additionally, more field information datastructures may be included based on the known range of management in the field.

TABLE 2

| | | | |
|---|---|---|---|
| Field Information Datastructure | τ + X₁ | . . . | τ + Xᵢ |

Data 1
Data 2
. . .
Data N

The model and the Agent may generate information upon running that captures model crop production attributes where t=1, model crop production attributes at each Agent forecast interval and Agent forecasted intervention recommendations at each Agent forecast interval.

In embodiments, the method 400 for updating information of the natural environment and the management practices on a set time interval includes a step 408 of retrieving sensor data. Data collection may occur in daily intervals or more frequently.

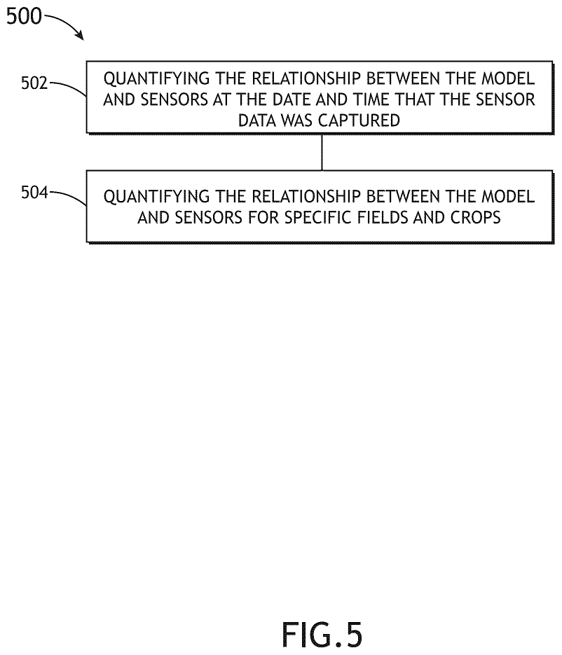

In embodiments, the method 200 may include a step 208 of quantifying a relationship between predicted field needs and actual field needs. FIG. 5 illustrates a flow diagram of a method 500 for quantifying a relationship between predicted field needs and actual field needs, in accordance with one or more embodiments of the present disclosure.

In embodiments, the method 500 for quantifying a relationship between predicted field needs and actual field needs includes a step 502 of quantifying the relationship between the model and sensors at the date and/or time that the sensor data was captured. If sensor data is not available for an iteration, quantifying the relationship between the model and sensors may not be performed. This process may be continuous, with a field-specific feedback system stored in the memory. Stored information may include the modeled growth stage, the reported growth stage, the modeled nutrient stress, the modeled nutrient demand, the measured nutrient stress sufficiency index (SI), the measured nutrient demand by plot, and the measured nutrient demand by date. The modeled and measured nutrient stress to sufficiency index ratio may be parameterized by the field management scenario (e.g., standard field management, limited field management, or excess field management). The curve fitting may be dynamically performed and used to define the relationship, where sufficiency index is the input and nutrient stress is the output. Additionally, the curve fitting may use any statistical techniques, such as, but not limited to, multivariate regression to define the modeled relationship. Information such as the curve fit, coefficients, and sufficiency of the fit may be stored in memory. If it is a linear relationship, Equation 1 may be used,

$${N\_Stress}_{measured} ( t ) = {R}^{★} ( SI ( t ) ) + {N\_Stress}_{baseline} where R is ( Δ N\_Stress ( t ) / Δ SI ( t ) ) \qquad Equation 1$$

The nutrient stress limit may be calculated using Equation 2.

$${N\_Stress}_{limit} ( t ) = {R}^{★} {SI}_{suff} ( t ) + {N\_Stress}_{baseline} \qquad Equation 2$$

And the difference in the measured and modeled nutrient stresses may be calculated using Equation 3, which may also be used the correct the nutrient stress forecast.

$${ε}_{{N}_{stress}} = {N}_{{Stress}_{measured}} - {N}_{{Stress}_{modeled}} \qquad Equation 3$$

The modeled and measured current nutrient demand may also be compared. The comparison may be done with Equation 4.

$${ε}_{N\_Demand \_Current} = N\_Demand {\_Current}_{measured} - N\_Demand {\_Current}_{modeled} \qquad Equation 4$$

If no Agent exists, then N_Demand_Currentmodeled may be the nutrient demand based on the correlation between the change in nutrient availability and change in nutrient stress over time. Characterizing the measured nutrient demand may be achieved by analyzing the change in sufficiency index (e.g., the change or difference in SI relative to the change or difference in nutrient expressed as the ratio between the two or delta_SI divided by delta_N) or the change in nutrient levels for the set of field information datastructures.

The modeled and measured nutrient demand forecast may also be compared. The comparison may be done with Equation 5.

$${ε}_{N\_Demand \_Forecast} ( t ) = N\_Demand {\_Forecast}_{measured} - N\_Demand {\_Forecast}_{modeled} \qquad Equation 5$$

If the Agent exists, then N_Demand_Currentmodeled may be the nutrient demand forecasted by Agent for t=T and at t=T−X. If no Agent exists, N_Demand_Currentmodeled may be the difference in nutrient demand based on correlation between nutrient stress and nutrient availability at t=T and that value estimated by State Model for t=T at t=T−X. Characterizing the measured nutrient demand may be achieved by analyzing the change in sufficiency index (e.g., the change or difference in SI relative to the change or difference in nutrient (or any other nutrient) expressed as the ratio between the two or delta_SI divided by delta_N) or the change in nutrient for the set of field information datastructures.

To verify the model, sampling may also occur at a field level or spatially (e.g., frequent soil sampling or frequent tissue sampling). Additionally, data may be collected from a local weather station or weather data base. Remote or proximal sensing may be performed to verify model outputs spatially.

In embodiments, the method 500 for quantifying a relationship between predicted field needs and actual field needs includes a step 504 of quantifying the relationship between the model and sensors for specific fields and crops. This may be performed by examining the nutrient stress error as a function of time, the nutrient demand error as a function of time, a current and calculated moving average of the nutrient stress error (e.g., uncertainty in the nutrient demand error through standard deviation across the current crop cycle), or a current and calculated moving average of the nutrient demand error (e.g., uncertainty in the nutrient stress error through standard deviation across the current crop cycle).

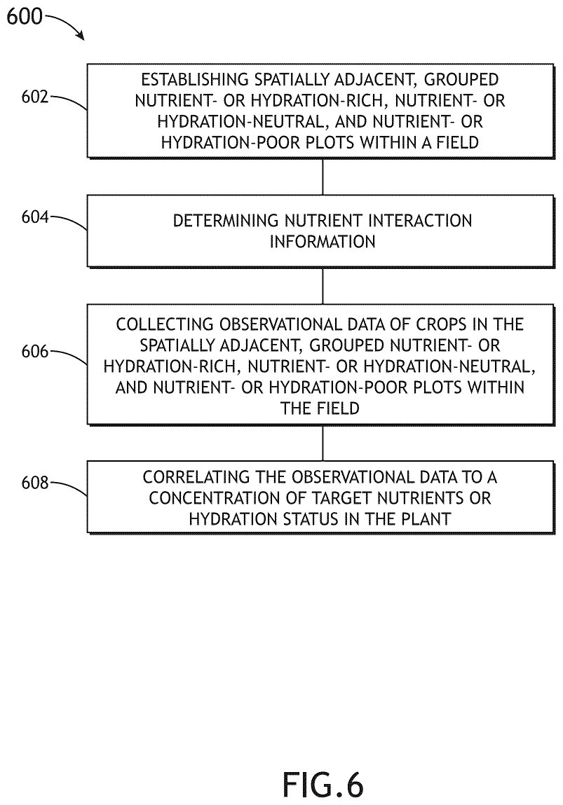

FIG. 6 illustrates a flow diagram of a method 600 for determining actual field needs based on observational data, in accordance with one or more embodiments of the present disclosure.

In embodiments, the method 600 for determining actual field needs based on observational data includes a step 602 of establishing spatially adjacent, grouped nutrient- or hydration-rich, nutrient- or hydration-neutral, and nutrient- or hydration-poor plots within a field using an input application of fertilizer, water, or other chemical/biological input.

In embodiments, the method 600 for determining actual field needs based on observational data includes a step 604 of determining nutrient interaction information. For example, it may be necessary to know if the nutrients are synergistic (e.g., if one nutrient is present it will make the other nutrient more available until there is not enough left to sustain the crop) or antagonistic (e.g., if more of one nutrient is present, it will limit the availability of the other nutrient).

In embodiments, the method 600 for determining actual field needs based on observational data includes a step 606 of collecting observational data of crops in the spatially adjacent, grouped nutrient- or hydration-rich, nutrient- or hydration-neutral, and nutrient- or hydration-poor plots within the field (e.g., by sensors or cameras). After the plots are established, observational data (e.g., acoustic data, radiative data, or thermal data) may be collected for each plot. The observational data collected may include data correlated to the expression or concentration of target nutrient(s) or hydration status in the plant. When the observational data is collected, it may be organized and related to other data through regressions, ratios, and other statistical techniques using the plot within which the target nutrient or hydration status was least present as a dynamic reference for full sufficiency. Regressions, ratios, and other statistical techniques may then be used to build a model of crop response to the target nutrient(s) or hydration status. Based on this model, management decisions can be made, such as the rate of an input to apply to correct the crop's sufficiency for target nutrient(s) or hydration status.

In embodiments, the method 600 for determining actual field needs based on observational data includes a step 608 of correlating the observational data to a concentration of target nutrients or hydration status in the plant.

For example, it may be necessary to know deficiency symptoms of a crop for the target nutrient or hydration level or availability of plant analysis for nutrient concentrations in the crop. By way of another example, it may be necessary to know the known expression of primary deficiency symptoms of the target nutrient or hydration level (e.g. crop height for Boron).

Implementation of an approach utilizing observational data may include the continuous training and/or development of an adaptive models (e.g., artificial intelligence/machine learning (AI/ML) models) describing total nutrient and hydration interaction based on a complete spectral signature. Further, detection can be leveraged for proof of placement of specific nutrients using before and after status.

It is noted that different nutrients may result in different observational data being collected from the crops. Additionally, nutrient presence (e.g., abundance or shortage) may have different effects on other nutrients. For example, nitrogen-rich and nitrogen-poor plots in corn may be established and observational data may be collected with sensors and/or cameras that includes a yellow waveband to produce a sulfur sufficiency model. A waveband (e.g., a waveband of light) may be a range of wavelengths falling between two given limits. A yellow waveband (e.g., 565-590 nanometers) may be necessary because sulfur deficiency may be expressed with top-of-plant yellowing. Vegetation indices and waveband specific reflectance in the direction of anticipated expression in a deficient state may be utilized to calibrate crop response. Higher nitrogen levels may require additional sulfur, so sulfur deficiency will appear in nitrogen-rich plots before it shows up in nitrogen-poor plots. Additionally, because higher nitrogen levels may create additional sulfur availability, sulfur deficiency may only appear if it is truly not available in adequate amounts. Therefore, the greater the disparity in yellow band reflectance between the nitrogen-rich and the nitrogen-poor plot when the nitrogen-poor plot exhibits similar or higher vegetation index values to the nitrogen-rich plot indicates a greater sulfur deficiency in the field. The ratio of yellow band reflectance between the nitrogen-rich and nitrogen-poor plot can be described as a sulfur sufficiency index that may be used to quantitatively inform sulfur fertilizer applications.

By way of another example, nitrogen-rich and nitrogen-poor plots may be established to monitor potassium levels. Potassium concentrations within the leaves from each plot and surrounding non-plot area may be collected. Then potassium concentrations across all nitrogen plot conditions may be measured to develop a potassium sufficiency model that can be used to inform rates of potassium application in-season. This may be applied to plant analyses across all nutrients that are measured using known relationships between nutrients and a minimum number of synergistic/antagonistic plots established within the field. Nutrient interactions may be determined using a database, such as, but not limited to, Mulder's chart.

By way of another example, potassium-rich and potassium-poor plots may be established. Observational data may be collected, including a blue waveband (e.g., 450-500 nanometers) or coastal blue waveband (e.g., 400-450 nanometers), to quantify phosphorus response. This may be done since phosphorus deficiency expresses as blue/purpling of the plant's upper leaves. Creating a phosphorus sufficiency model, and using the phosphorus sufficiency model to determine the appropriate application rates may be done based on the operational data collected.

Using observational data may offer several advantages for crop monitoring and management. It may isolate specific nutrient or hydration responses, enabling more targeted insights. The system may adaptively and dynamically train models for each cultivar, eliminating the need for historical production data and requiring little to no user input. Additionally, observational data does not rely on genetic modification, making it suitable for use in non-GMO and organic production systems. It may also be tailored to specific fields and may not require high spectral resolution, making it more accessible and practical for a variety of agricultural settings.

The only physical structure directly involved may be the crop itself and sensors to collect observational and supply it to processors in order to interpret the observational data from the crops. The crops may develop variation in response to local environmental conditions such as nutrient deficiency, nutrient excess, or changes in hydration. Additionally, information may be provided based on the interpretation of the observational data, including, but not limited to, example spectral signatures, guidance for model development and decision support, as well as sample plot layouts illustrating how specific nutrients and hydration levels influence plant development.

In embodiments, the method 200 may include a step 210 of calibrating based on the relationship between the predicted field needs and the actual field needs.

For example, calibrating based on the relationship between the predicted field needs and the actual field needs may include calibrating sensor data based on the managed parameter response. If sensor data is not available for an iteration, calibrating the sensor data may not be performed. Attributes that may be produced include sufficiency index (SI) values, change in nutrient or sufficiency index (e.g., the change or difference in sufficiency index relative to the change or difference in nutrients expressed as the ratio between the two or delta_SI divided by delta_N), or actual nutrient demand. Calibration may be performed using paired or grouped plot calibration and/or augmented simulant calibration.

In embodiments, the method 200 may include a step 212 of providing recommendations based on the predicted field needs.

If sensor data of an acceptable quality is unavailable, then the model may be run to predict nutrient stress and nutrient demand for an upcoming period of time within the crop growing season (e.g., 10-14 days, or longer). If a calibrated nutrient stress threshold is available, then the predicted nutrient stress may be compared to it. If the predicted nutrient stress exceeds the current calibrated nutrient stress threshold, management intervention may be recommended. If the nutrient stress is less than the current calibrated nutrient stress threshold, management intervention may not be recommended.

Recommendations of a nutrient rate (e.g., applied spatially) and an interval within which to apply to satisfy the nutrient demand of the period of time may be made with the current nutrient demand error added to the amount. Additionally, recommendations of an optimal product formulation to satisfy crop nutrient demand on the basis of anticipated product available based on factors such as, but not limited to availability given soil moisture, temperature, and anticipated crop nutrient demand may be made. The user may be notified which model was used to make management recommendations.

If sensor data of acceptable quality is available, then the nutrient stress measurement from a paired plot or from simulant calibration may be used to compare against the nutrient stress threshold to determine if nutrient stress is approaching. If nutrient stress is not approaching, no management intervention will be recommended.

If nutrient stress is approaching, the measured nutrient demand for the sufficiency index and the forecasted nutrient demand from the optimized mode for the next period of time for the field or across all management practices in a field may be obtained. The model may then produce minimum and maximum bounds. Additionally, a prescription may be created that spatially satisfies the anticipated nutrient demand for the upcoming period of time in the field and the interval at which to apply the nutrient. Optimal product formulation may also be recommended in order to satisfy crop nutrient demand on the basis of anticipated product availability given factors such as, but not limited to availability given soil moisture, temperature, and anticipated crop nitrogen demand may be made. The user may be notified which sources (e.g., model and/or sensor) were used to make management recommendations.

In embodiments, the method 200 may include a step 214 of learning based on a comparison of the predicted field needs and the actual field needs.

The Agent may be trained to optimize itself for new targets as a function of the estimated growth stage and date from the model based on the error by growth stage and date in the collected data. An actual outcomes data simulated dataset may be built with measured outcomes for nutrient stress and nutrient demand based on historical imagery and weather. The trained Agent performance may be tested based on a dataset of the actual outcomes. These learning procedures may be repeated regularly. Additionally, they may also be performed with an artificial intelligence (AI) or machine learning (ML) model.

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A system, comprising:
a controller, wherein the controller includes one or more processors configured to execute program instructions stored on memory, the program instructions configured to cause the one or more processors to:
receive information of a natural environment and management practices;
initiate automated data collection;
update information of the natural environment and the management practices on a set time interval;
quantify a relationship between predicted field needs and actual field needs;
calibrate based on the relationship between the predicted field needs and the actual field needs; and
provide recommendations based on the predicted field needs.

2. The system of claim 1, wherein the program instructions are further configured to cause the one or more processors to:
learn based on a comparison of the predicted field needs and the actual field needs.

3. The system of claim 2, wherein the system learns based on a machine learning or artificial intelligence algorithm.

4. The system of claim 1, wherein the information of the natural environment and the management practices includes at least one of:
field boundary, crop type, crop hybrid, maturation data, phenotypic performance data, nutrient applications, tillage information, planting information, harvest information, or soil information.

5. The system of claim 1, wherein the relationship between the predicted field needs and the actual field needs is analyzed for at least one of:
date of capture, field, or crop type.

6. The system of claim 1, wherein the field needs include at least one of:
nutrient stress or nutrient demand.

7. The system of claim 1, wherein the system analyzes a presence of at least one of nitrogen (N), sulfur(S), potassium (K), phosphorus (P), boron (B), magnesium (Mg), zinc (Zn), manganese (Mn), calcium (Ca), iron (Fe), molybdenum (Mo), copper (Cu), or chlorine (Cl) in soil.

8. The system of claim 1, further comprising:
one or more sensors communicatively coupled to the controller, wherein the one or more sensors are configured to collect the information of the natural environment.

9. The system of claim 1, further comprising:
a user interface communicatively coupled to the controller, wherein the user interface is configured to display at least one of the predicted field needs.

10. The system of claim 1, further comprising:
nutrient application equipment.

11. The system of claim 10, wherein the program instructions are further configured to cause the one or more processors to:
control the nutrient application equipment based on determinations of field needs.

12. The system of claim 1, wherein the actual field needs are determined by observational data collected from the natural environment.

13. The system of claim 12, wherein the observational data is based on nutrient interaction caused by spatially adjacent, grouped plots.

14. The system of claim 13, wherein the spatially adjacent, grouped plots include a nitrogen-rich plot and a nitrogen-poor plot.

15. The system of claim 14, wherein the nitrogen-rich plot and a nitrogen-poor plot result in observational used to produce a sulfur sufficiency model.

16. The system of claim 12, wherein the observational data is one or more wavebands of light.

17. The system of claim 16, wherein the one or more wavebands of light is at least one of a yellow waveband corresponding to sulfur, a blue waveband corresponding to phosphorus, or a coastal blue waveband corresponding to phosphorus.

18. The system of claim 1, wherein the recommendations based on the predicted field needs are provided based on the information of the natural environment.

19. The system of claim 1, wherein the recommendations based on the predicted field needs are provided based on a model when the information of the natural environment is insufficient, wherein the model provides a recommendation for a defined future time period.

20. A system, comprising:
one or more sensors;
nutrient application equipment; and
a controller, wherein the controller includes one or more processors configured to execute program instructions stored on memory, the program instructions configured to cause the one or more processors to:
receive information of a natural environment and management practices, wherein the one or more sensors collect the information of the natural environment;
initiate automated data collection;
update information of the natural environment and the management practices on a set time interval;
quantify a relationship between predicted field needs and actual field needs;
calibrate based on the relationship between the predicted field needs and the actual field needs;
provide recommendations based on the predicted field needs; and
control the nutrient application equipment based on determinations of field needs.

21. The system of claim 20, wherein the program instructions are further configured to cause the one or more processors to:
learn based on a comparison of the predicted field needs and the actual field needs.

22. A method, comprising:
receiving information of a natural environment and management practices;
beginning automated data collection;
updating information of the natural environment and the management practices on a set time interval;
quantifying a relationship between predicted field needs and actual field needs;
calibrating based on the relationship between the predicted field needs and the actual field needs; and
providing recommendations based on the predicted field needs.

23. The method of claim 22, further comprising:
learning based on a comparison of the predicted field needs and the actual field needs.

24. The method of claim 23, wherein the learning based on a comparison of the predicted field needs and the actual field needs is performed with artificial intelligence or machine learning.

25. The method of claim 22, wherein the information of the natural environment and the management practices includes at least one of:
field boundary, crop type, crop hybrid, maturation data, phenotypic performance data, nutrient applications, tillage information, planting information, harvest information, or soil information.

26. The method of claim 22, wherein the relationship between the predicted field needs and the actual field needs is analyzed for at least one of:
date of capture, field, or crop type.

27. The method of claim 22, wherein the field needs include at least one of:
nutrient stress or nutrient demand.

28. The method of claim 22, further comprising:
analyzing a presence of at least one of nitrogen (N), sulfur(S), potassium (K), phosphorus (P), boron (B), magnesium (Mg), zinc (Zn), manganese (Mn), calcium (Ca), iron (Fe), molybdenum (Mo), copper (Cu), or chlorine (Cl) in soil.
